(19) United States
(12) Patent Application Publication
(10) Pub. No.: US 2011/0055895 A1
(43) Pub. Date: Mar. 3, 2011

(54) Shared scalable server to control confidential sensory event traffic among recordation terminals, analysis engines, and a storage farm coupled via a non-proprietary communication channel

(75) Inventors: STEVEN GODDARD ROSKOWSKI, LOS GATOS, CA (US); PAUL H. FORRESTER, SAN JOSE, CA (US)

(73) Assignee: Third Iris Corp., GRAND CAYMAN (KY)

(21) Appl. No.: 12/578,008

(22) Filed: Oct. 13, 2009

Related U.S. Application Data
(63) Continuation-in-part of application No. 12/551,239, filed on Aug. 31, 2009.

(51) Int. Cl. H04L 9/32; G06F 15/16; H04N 7/167; H04L 9/08

(52) U.S. Cl. 726/3; 709/231; 709/228; 380/200; 709/219; 380/278

(57) ABSTRACT

A highly secure sensory stream event server receiving and storing encrypted assets and references to those assets over a non-proprietary communications channel. A system for selectively decrypting and transmitting references to analysis clients such as authenticated mutually unconscious users, and retrieving, decrypting and transmitting certain assets from high-volume storage, distributed storage, or in transit. A method for controlling a plurality of sensory stream event recordation clients and a plurality of analysis clients transmitting policies and commands requesting upload of assets and obtaining status solely by receiving client initiated sessions.

### CROSS-REFERENCE TO RELATED PATENTS

This application is a CIP of Ser. No. 12/551,239 filed Aug. 31, 2009 A SHARED SCALABLE SERVER TO CONTROL CONFIDENTIAL EVENT TRAFFIC AMONG RECORDATION TERMINALS, ANALYSIS ENGINES, AND A STORAGE FARM COUPLED VIA A PUBLIC NETWORK U.S. Pat. No. ______ issued ______ by the present inventor which is incorporated by reference.

### BACKGROUND

Security cameras are increasingly important for both enterprises and consumers. All levels of government are promoting installation of cameras to address fears of crime. Liability insurers may raise rates on customers who cannot document that their premises are controlled. By high complexity image sequences the present invention includes high resolution digital photographs, lower resolution moving images in the form of a series of video frames, meta-data about the time, place, and conditions of the image, and derived data from quantitative metrics of the images and compressed low resolution extracts from images.

Internet Protocol (IP) network digital cameras are known as an accepted solution for security and monitoring. Utilizing IP networks instead of dedicated video connections to a local server dramatically improves system flexibility and can reduce connectivity and management complexity. Conventional IP network camera system design requires “logging in” to each camera. Typically, each camera implements a website for user access.

Conventional implementations require extensive network application and system engineering and only result in transfer of limited amounts of information. For example it is observed by the inventors that configuration of each network environment consists at least of opening ports, mapping addresses, managing a difficult maintenance and operations model to be assured that the system is working when needed, and addressing security concerns. For example, is the equipment on premises vulnerable to theft or damage, can end users properly configure the network and the specific camera device, what steps are needed to easily record and analyze the video.

To allow live access to cameras, a user should be able to configure firewalls if external access is to be allowed and to configure an IP address resolution service such as a dynamic domain name system (DNS) application. Because the solution depends on an occasional user to define and configure each security installation, deployed solutions have been known to exhibit very poor security such as unintended publicly viewable webcams.

Conventional video security systems do not enable proactive monitoring of their status. End users occasionally discover when an event occurs in their premises, that their system was not functioning correctly and that they do not have the desired critical information despite having made investments into both cameras and recording systems. Since video monitoring systems are typically not core to the business of most enterprises, but supportive, the resources allocated to maintain the system are frequently inadequate, insufficient, or lack the proper expertise to maintain the system effectively. This results in many video systems being effectively turned off after a period of time as the cost and complexity of maintaining the system overwhelms the day to day benefits. Only the largest governmental or private enterprises have continuous human monitoring of all cameras.

The challenge of maintaining operational systems has been addressed in other domains effectively by adopting a “service model” where minimal equipment is onsite and a centralized service provides functionality to a large pool of users. Video monitoring has historically been unable to use this model effectively due to the high bandwidth required to effectively record usable quality video. While this bandwidth can be addressed in local area networks, a service model with centralized recording requires video to be sent over a wide area network such as the Internet, and such connection may be costly and typically limited. For example many business have traditionally had “T1” connectivity, which is bidirectional at about 1 megabit per second. A single camera with high quality video in traditional implementations uses 2-3 megabits of bandwidth, making a conventional service based model impractical.

The benefits of a service based model would be significant. One key benefit is the ability to use shared resources across a larger number of customers. This amortizes the cost of equipment, monitoring and maintenance, allowing very high levels of service at manageable costs. In the area of equipment and management, it is known a single logical storage volume, potentially made up of a very large number of physical volumes, can be shared amongst a large number of users if there are sufficient safeguards for privacy. Using a single large logical storage volume allows for significant individual variance in usage patterns to be efficiently addressed. A single large logical storage volume also allows additional reliability and maintenance investments to be amortized over the entire user set, significantly increasing reliability and reducing costs.

These storage models have been optimized in a computational architecture commonly called “cloud computing”. In cloud computing a very large number of machines and a very large amount of logical storage is made available in an on-demand basis to a large body of customers. Customers can increase and decrease the amount of computational resources allocated to them on a demand basis. Each computation resource is some version of a virtual machine, which can then be further partitioned into individual user computation needs as outlined above. Cloud computing also provides cloud storage, where a very large amount of storage is made available on a demand basis, allowing customers to allocate and de-allocate storage as needed.

It is known in the art that processors as disclosed in the conclusion adapted by software programs provide means.

We define an asset to be a full record of data that elaborates an event as defined by a policy transmitted to an event recordation client from the event recordation server. Non limiting examples of assets include high resolution digital images or video streams but could be audio streams, detailed data or logs. We define a reference to be a summary of an asset that is relatively compact. Non-limiting examples of references include an event type and a time stamp, a low resolution image of a face, license plate, or a photograph or a text report such as generated by voice recognition, character recognition, object recognition, pattern recognition, or facial recognition codes.

Thus it can be appreciated that what is needed is a server apparatus which supports immediate timely upload of references and delayed, and optional upload of assets according to demand, policies, and analysis clients operating on references. Thus it can be appreciated that what is needed is a server apparatus which makes deployment, maintenance, and operation of IP network cameras or other sensory capture devices much less complex. Analog and digital radio transceivers are alternate communication channels which are not proprietary ie. can be monitored by unauthorized observers.

### SUMMARY OF THE INVENTION

Within the scope of the present patent application we define an event as the collection of meta-data and assets which represent the recordation of an occurrence of interest at a point of recordation terminal (PORT). The present invention comprises a secure event server comprising:
a event recordation (capture) server circuit,
to receive references from an event recordation (capture) client, such as a point of recordation terminal,

to retrieve assets from at least one event recordation (capture) client,
to receive status from and transmit commands to each event recordation (capture) client,
to receive assets from a event recordation client incrementally according to bandwidth policy or a demand for immediate elaboration. In an embodiment an asset is retrieved and stored in encrypted format. In an embodiment an asset is retrieved and stored in digitally signed format.

The present invention comprises a secure sensory stream event server comprising:
a capture server circuit, to receive references from a capture client, to receive status from and transmit commands to each capture client, to receive encrypted sensory stream assets from a capture client incrementally according to bandwidth policy or a demand for immediate fulfillment. In an embodiment, references include camera id, date & time, as well as optionally meta data and thumbnails according to downloaded policies. In an embodiment a sensory stream is video. In an embodiment, a sensory stream is audio. In an embodiment, a sensory stream is data from measurement instruments. Non-limiting exemplary measurement instruments include: orientation, acceleration, temperature, pressure, electro-magnetic fields, pressure, and chemical, radiation, and biological sensors.

The invention also includes a location server and a storage manager circuit,
to maintain location of assets for every event, and
to retrieve assets from at least one storage server.

The invention also includes an analysis server coupled to analysis clients. In an embodiment, an analysis server provides access to references, meta-data, and assets to an analysis client which may be a person or a program performing such non-limiting examples of analysis as follows: an image or character recognition function, a facial recognition function, object permanence or impermanence detection or motion detection. In an embodiment, an analysis server comprises a display server circuit, to decrypt video assets for authenticated users, to show a video stream for a selected event, to show a plurality of scaled, still images for a plurality of events.

This server provides seamless access to assets which may be in any one of a plurality of states. It provides using a location server, command server, and storage server:
Means for determining if a certain asset is currently stored locally and means for transmitting the asset to the requesting analysis client
Means for determining asset is stored remotely and directing request to appropriate resource for resolving a remote asset
Means for handling assets which are in process of being resolved as request is made
   wherein means comprise a processor adapted by stored commands, including converting asset request into sequence of commands to upload asset.

This server stores assets encrypted and selectively decodes assets on demand at either server or analysis client depending on analysis client capabilities.

This server supports event recordation clients which are point of recordation terminals (PORTs) which utilize only PORT initiated transactions for both assets and command interactions. This server comprises a switchboard to allow multiple servers to track status of connection, to issue commands on command channel, and to influence asset data transfer channel by sending policies.

This server automatically manages PORT configurations, including managing software configuration, dynamic status, service configuration, user preferences, and computational algorithms.

A highly secure event server receives and stores encrypted assets and references to those assets over a non-proprietary communication channel. A system selectively decrypts assets to authenticated mutually unconscious users, and retrieves, decrypts and serves certain assets from high-volume storage, distributed storage, or in transit. The method controls a plurality of recordation clients and a plurality of analysis engines transmitting policies and commands, requesting upload of assets, and obtaining status solely by receiving client initiated sessions. In an embodiment, a recordation client is a camera. In an embodiment, a recordation client is a microphone. In an embodiment, a recordation client is a measurement instrument. In an embodiment, a recordation client is the engine and control surface parameters of a vehicle such as a train, plane, car, or spacecraft.

### BRIEF DESCRIPTION OF DRAWINGS

FIG. 1 is a block diagram of a server.

FIG. 2 is a block diagram of a server.

FIG. 3 is a flowchart of a method.

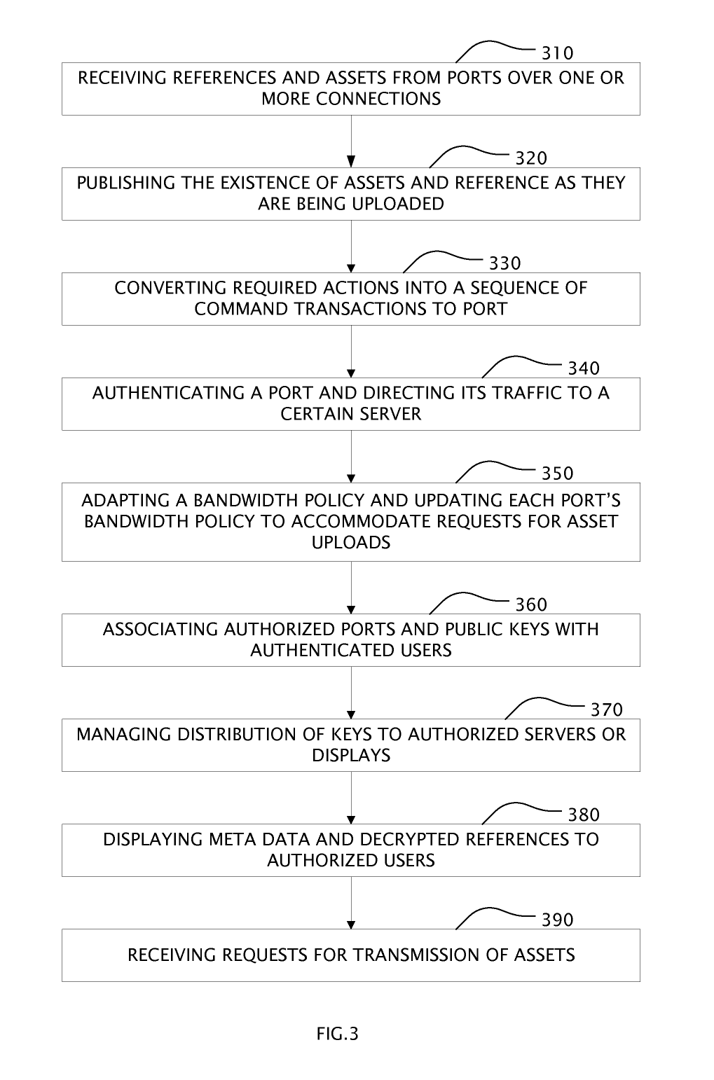

FIG. 4 is a block diagram of a server.

FIG. 5 is a block diagram of a server.

FIG. 6 is a block diagram of a server.

FIG. 7 is a flowchart of a method.

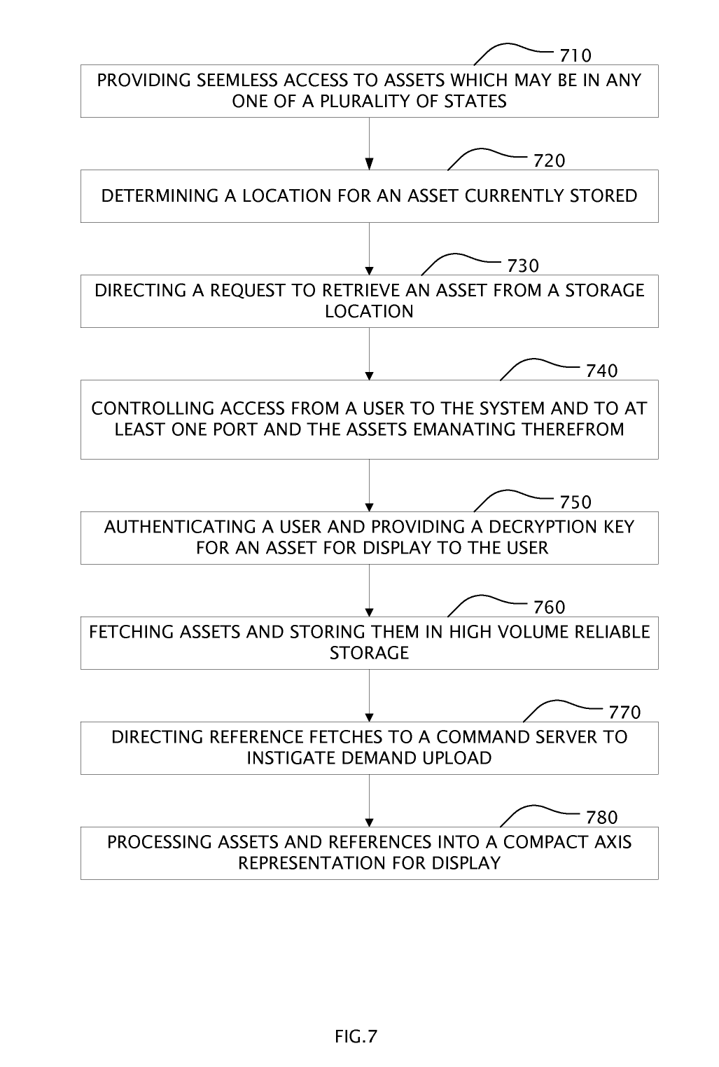

FIG. 8 is a block diagram of a server.

### DETAILED DESCRIPTION OF EMBODIMENTS

An embodiment of the invention is an apparatus coupled to a low-bandwidth communication channel, the channel coupled to a plurality of at least one of a microphone and a camera, the apparatus adapted to receive a compact audio sample or a low resolution still image representative of a larger digital stream stored at the microphone or camera.

An embodiment of the invention further comprises a circuit to respond to at least one of a microphone and a camera with an instruction to upload a stream of data.

An embodiment of the invention is an apparatus comprising
at least one sensory stream server coupled to both a command server and to a storage server, a sensory stream server comprising:
   a switchboard circuit, and
   an asset storer circuit,
wherein the asset storer circuit receives assets and references over a communication channel as determined by a point of recordation terminal (PORT) and
wherein the switchboard circuit couples all PORTs and all servers enabling the transfer of commands and status between any PORT and any server.

In an embodiment of the invention the assets and references comprise representations of chunks of data which represent meaningful partition of a data stream.

In an embodiment of the invention the asset storer circuit is adapted to process data as chunks are received to improve performance and latency in handling large data streams.

In an embodiment of the invention the chunks comprise meaningful sensory groupings.

In an embodiment of the invention a meaningful sensory grouping is at least one frame of video.

In an embodiment of the invention a meaningful sensory grouping is at least one sample of audio.

In an embodiment of the invention a communication channel comprises a circuit adapted to perform instructions specified by Internet Protocol standard.

In an embodiment of the invention a communication channel comprises a circuit adapted to perform instructions specified by TCP/IP standard.

In an embodiment of the invention a communication channel comprises a circuit adapted to perform instructions specified by hypertext transfer protocol standard.

In an embodiment of the invention a communication channel comprises a circuit adapted to perform instructions specified by hypertext transfer protocol standard POST method.

In an embodiment of the invention a communication channel comprises a circuit adapted to perform instructions specified by hypertext transfer protocol standard POST method chunk based transfer encoding.

In an embodiment of the invention the apparatus further comprises
at least one sensory stream server coupled to both a command server and to a storage server, a sensory stream server comprising:
   a switchboard circuit, and
   an asset storer circuit,
wherein the asset storer circuit receives assets and references over an http protocol POST method initiated by a PORT and transfer encoded as chunks as determined by the PORT and
wherein the switchboard circuit couples all PORTs and all servers enabling the transfer of commands and status between any PORT and any server.

In an embodiment of the invention the apparatus further comprises:
a location server comprising
   a PORT authentication circuit and
   a PORT routing circuit,
wherein a location server resides at a fixed address known by the PORT whereby any PORT can establish a connection to a location server without depending on a name resolution service or a network service which requires local network knowledge.

In an embodiment of the invention the apparatus further comprises
a location server comprising
   a PORT authentication circuit and
   a PORT routing circuit,
wherein a location server comprises a fixed Internet protocol address whereby any PORT can establish a connection to a PORT server without depending on the domain name system, and
wherein location information is provided to servers which need to find a certain PORT.

In an embodiment of the invention the apparatus further comprises an analysis server coupled to at least one of an analysis client and an analysis process. The client or process performs an evaluation of each reference to determine if it is not of further interest or if the event should be elaborated and the referenced asset should be retrieved for additional analysis, the analysis server comprising a processor adapted by software instructions providing
means for performing regression analysis on event meta data
means for summarizing event meta data
means for correlating meta data among related capture clients,
means for performing specific analysis upon recognition of a trigger event,
means for categorizing events by meta data, and
means for alerting a user to a certain pattern of events.

In an embodiment of the invention a sensory stream comprises orientation.

In an embodiment of the invention a sensory stream comprises temperature.

In an embodiment of the invention a sensory stream comprises pressure.

In an embodiment of the invention a sensory stream comprises acceleration.

In an embodiment of the invention a sensory stream comprises electro-magnetic field.

In an embodiment of the invention a sensory stream comprises audio.

In an embodiment of the invention a sensory stream comprises video.

An embodiment of the invention comprises a secure video stream event server comprising:
a capture server circuit
   to receive a reference from a capture client,
   to receive status from and transmit commands to each capture client,
   to receive encrypted video stream assets from a capture client according to an bandwidth shaping policy for incremental fulfillment or according to a demand for immediate fulfillment,
a location manager circuit and a storage manager circuit,
   to maintain location of video assets for every captured event, and
   to retrieve video assets from capture client,
   to retrieve video assets from storage server, and
an analysis server.

In an embodiment of the invention a video stream assets is an encrypted video stream asset whereby confidentiality is protected over a public communication channel.

In an embodiment of the invention the capture server circuit further comprises a circuit or processor adapted by software instructions:
to enable access to a capture client by an authenticated authorized user,
to transmit bandwidth policies to each capture client,
to transmit updates to event capture policy,
to transmit updates to meta data capture policy, and
to accept connectivity requests from authenticated capture clients.

An embodiment of the invention comprises a method for operating a system,
the system comprising,
   a plurality of analysis clients coupled to an analysis server,
   the analysis server coupled to a storage server, and
   the storage server,
the method comprising the following processes:
   providing seamless access to assets which may be in any one of a plurality of states,
   determining a location for an asset currently stored,
   directing a request to retrieve an asset from a storage location,
   controlling access from a user to the system and to at least one PORT in the assets emanating therefrom,
   authenticating a user and providing a decryption key for a user to access an asset,
   fetching assets and storing them in high volume reliable storage,
   directing reference fetches to a command server to instigate demand upload, and
   processing assets and references into a compact axis representation for display.

In an embodiment of the invention a system is a secure system, and the method comprising authenticating authorized users and encrypting and decrypting references and assets for authenticated authorized users.

In an embodiment of the invention assets are encrypted assets and the method further comprises receiving and storing encrypted assets.

In an embodiment of the invention the method further comprises storing a decryption key for an assets, authenticating an authorized user before providing a decryption key and one of transmitting the decryption key to a user or decrypting an asset for an authenticated authorized user.

In an embodiment of the invention further comprises the following processes:
receiving references and assets from PORTs over one or more connections,
publishing the existence of assets and references as they are being uploaded
converting required actions into a sequence of command transactions to PORTs,
authenticating a PORT and directing its traffic to a certain server, and
adapting a bandwidth policy and updating each PORT's bandwidth policy to accommodate requests for asset uploads.

In an embodiment of the invention the method further comprises the steps following:
associating authorized PORTs and public keys with authenticated users,
managing distribution of keys to authorized servers or displays,
displaying meta data and decrypted references to authorized users, and
receiving requests for transmission of assets.

The server is adapted to operate coupled through a non-proprietary communication channel to an event recordation client comprising
an encryption circuit,
a event determination policy,
an event recognition circuit,
means for digitally signing an asset documenting the time and locus of an event recognition, and
means for summarizing an asset into a compact reference, wherein means comprises a circuit or processor adapted by a software program.

In an embodiment the server apparatus, comprising a processor adapted by software encoded on computer readable media, further provides, using a location server, a command server, and a event recordation server:
means for transmitting to an event recordation client a demand for immediate transmission of an asset, and
means for transmitting to an event recordation client a policy for delayed transmission of an asset according to an allocation of bandwidth.

In an embodiment the apparatus further provides means for policy distribution to non-proprietary communication channel attached event recordation apparatus by a processor adapted by a program product and a network interface.

In an embodiment the means for policy distribution comprises a software update circuit providing code to define meta-data to be uploaded.

In an embodiment the means for policy distribution comprises a software update circuit providing code to define an event to be recorded.

In an embodiment the means for policy distribution comprises a software update circuit providing code to define an asset to be stored and transmitted.

In an embodiment the apparatus further provides means for quantifiably provable provenance through
a decryption circuit,
a record of the keys for each event recordation apparatus,
a circuit to receive a digitally signed asset for an event,
a circuit to store a digitally signed asset.

The invention comprises a method for operating a non-proprietary communication channel attached event recordation asset server comprising:
receiving a client initiated protocol to establish connectivity,
receiving a client initiated protocol to transmit a reference to an event,
receiving a client initiated protocol to transmit an asset,
storing a reference,
receiving an analysis client request for an asset,
locating an asset,
redirecting a asset currently in transit,
reading an asset from storage,
transmitting a demand to client, and
storing an asset, without decrypting the asset.

The present invention comprises a method for operating an event recordation system provisioning a quantifiably provable provenance process comprising the steps of:
on an event recordation client apparatus:
   determining an event,
   digitally signing an asset for the event,
wherein digitally signing mathematically combines the identification of the event recordation client apparatus, the time and date, and the content of the asset in a way that any modification is quantifiably detectable,
   transmitting a reference to the asset, and
   transmitting a digitally signed asset to a server;
on an event recordation server apparatus:
   storing a digitally signed asset,
   reading a key for a certain event recordation client apparatus, and
   determining a time date and identity of the event recordation client apparatus which determined the event and signed the asset.

In an embodiment the method further comprises on an event recordation client apparatus:
digitally signing the asset for the event,

wherein digitally signing mathematically combines the identification of the event recordation client apparatus, the time and date, and the content of the asset in a way that any modification is quantifiably detectable,
transmitting a reference to the asset, and
elaborating the reference by transmitting a digitally signed and encrypted asset to a server;
on an event recordation server apparatus:
   storing a digitally signed and encrypted asset,
   validating a certain event recordation client apparatus, and
   determining a time date and identity of the event recordation client apparatus which determined the event and signed the encrypted asset.

The present invention comprises a method for operating a event server apparatus, the apparatus comprising a command server, a network interface, a storage manager, an event recordation server; the method comprising the steps:
receiving and maintaining a client session from a event recordation client apparatus,
receiving and storing a reference and
in processing an analysis server request for an asset, responding to a client request with a command to priority upload an asset.

The present invention comprises a method for operating an event server apparatus, the apparatus comprising a command server, a network interface, a storage manager, an event recordation server; the method comprising the steps:
receiving and maintaining a client session from a event recordation client apparatus,
receiving and storing a reference and receiving a bandwidth shaped upload of an asset related to the reference.

In an embodiment the method further comprises the step of in processing an analysis server request for an asset, responding to a client request with a command to priority upload an asset related to the reference whereby an asset already in transit by bandwidth shaped upload is completed by priority upload.

In an embodiment the asset is digitally signed within the event recordation client apparatus for quantifiably provable provenance the method further comprises the steps:
receiving and storing a digitally signed asset,
validating a certain event recordation client apparatus, and
determining a time date and identity of the event recordation client apparatus which determined the event and signed the asset.

In an embodiment whereby the asset is received and stored in encrypted format within the event recordation client apparatus for privacy and not decrypted until accessed by authenticated analysis client the method further comprises the steps:
receiving and storing an encrypted asset,
authenticating an authorized analysis client, and
decrypting the asset only at the request of an authenticated authorized analysis client whereby the asset is protected in storage and during transmission by an encryption at the event recordation client apparatus and not merely by a transport layer protocol.

In an embodiment the asset is both encrypted for privacy and digitally signed for provenance by the method further comprising the steps:
receiving and storing a digitally signed and encrypted asset,
reading a key for a certain event recordation client apparatus, and
determining a time date and identity of the event recordation client apparatus which determined the event and signed the encrypted asset.

In an embodiment an event further comprises a server recognized event which is initiated by a process within the server further comprising the steps:
receiving an asynchronous interrupt from a server, analysis client, or other source to initiate a demand for event creation, asset transfer, and reference for a certain camera,
receiving and maintaining a client session from an event recordation client apparatus,
responding to a client request with a command to create an event, and at least one reference and asset and priority upload the asset to the server.

In an embodiment the invention comprises a network attached event recordation server comprising:
a decryption circuit,
means for receiving and storing a reference,
means for receiving and storing an asset,
means for decoding the time and locus of an event recognition
wherein locus is the unique serial number of an event recordation client having a certain key
wherein means comprise a processor adapted by computer readable instructions.

In an embodiment the invention comprises a non-proprietary communication channel attached event recordation asset server apparatus comprising
an event recordation server,
analysis server,
storage manager circuit,
a storage server,
a network interface coupled to at least one event recordation client apparatus

wherein said event recordation server responds to a client initiated session to provide status, transmit references and assets, and obtain commands and

wherein said storage manager circuit maintains location information for every asset among three classes: in transit between the recordation client and the server, stored at the storage server, or stored at the event recordation client.

The invention comprises a method for operating an event recordation system over a non-proprietary communication channel comprising a quantifiably provable provenance process comprising the steps of:
on an event recordation client apparatus:
   determining an event,
   encrypting an asset for the event,
   transmitting a reference to the asset, and
   elaborating the reference by transmitting an encrypted asset to a server;
on an event recordation server apparatus:
   storing an encrypted asset without decrypting the asset,
   reading a key for a certain event recordation client apparatus, and
   determining a time date and identity of the event recordation apparatus for a certain asset.

The invention comprises an event server apparatus comprising:
a event recordation server circuit
   to receive a reference from a event recordation client,
   to receive status from and transmit commands to each event recordation client,
   to receive assets from a event recordation client according to an bandwidth shaping policy for incremental fulfillment or according to a demand for elaboration,
a command server, to retrieve assets from an event recordation client,
a location server,
a storage manager circuit,
   to maintain storage location of assets, and
   to retrieve assets from storage server, and
an analysis server to determine which references are of interest.

In an embodiment the apparatus further provides means such as a processor coupled to a network interface, for transmitting an update to a event recordation client apparatus comprising configuration for determining an event, performing analysis, uploading meta-data, and transmitting a reference.

In an embodiment the apparatus further provides means such as a command server and a network interface for forcing an immediate event determination to a selected event recordation client apparatus.

In an embodiment the apparatus further comprise an authentication and decryption circuit,
and means for receiving and storing an asset in a digitally signed format;
which prevents modification of the time of day, the asset, or the identification of the event recordation apparatus without detection, whereby provenance of the asset is quantifiably measurable and proven.

In an embodiment the apparatus further comprise
an authentication and decryption circuit, and
means such as a circuit for receiving and storing an asset in an encrypted format without decrypting it;
whereby an asset may be transmitted through a non-proprietary communication channel and stored in a shared use server without revealing the contents to unauthenticated or unauthorized parties sharing the network or server apparatus.

In an embodiment the command server comprises a circuit to
receive a request for an asset,
determine location of a asset stored on a certain event recordation client,
determine a command sequence to retrieve and deliver the asset, and
respond to an open session established by the event recordation client with a command sequence to immediately upload the asset with priority over any other event recordation client traffic.

In an embodiment, the invention comprises a method for operating a system,
the system comprising,
   a plurality of analysis client apparatus coupled to an analysis server apparatus by a network,
   the analysis server apparatus coupled to a storage server apparatus, and
   the storage server apparatus,
the method comprising the following processes:
   providing access to assets which may be in any one of a plurality of states,
   determining a location for an asset currently stored,
   directing a request to retrieve an asset from a storage location, and
   fetching assets and storing them in high volume reliable storage.

In an embodiment the method for operating a non-proprietary communication channel attached event recordation asset server further comprises distributing a policy to a non-proprietary communication channel attached event recordation apparatus wherein a policy is a computer executable instruction to adapt a processor to transform data tangibly encoded on computer readable media.

In an embodiment the policy determines an event based on object recognition rules.

In an embodiment the policy determines an event based on facial recognition rules.

In an embodiment the policy determines an event based on object placement or movement.

In an embodiment the policy determines an event based on duration of occupancy within a part of an image field.

In an embodiment the policy determines an event based on a repetition of motions.

In an embodiment the policy determines an event based on motion detection and time of day & day of week.

In an embodiment the policy determines which meta data is transmitted by type of event.

In an embodiment the policy determines if a low resolution video frame is included in a reference.

In an embodiment the policy determines if a high resolution image is included in an asset.

In an embodiment the policy determines the immediacy of transmitting an asset to a server.

In an embodiment the policy determines the immediacy of transmitting a reference to a server.

In an embodiment the apparatus further comprises means such as a circuit, software, or processor adapted by a program product. for transmitting an update to a event recordation client apparatus configuration for determining an event, performing analysis, uploading meta-data, and transmitting a reference.

In an embodiment the apparatus further comprises means for forcing an event determination to a selected event recordation client apparatus.

The present invention comprises a secure event server comprising:
a event recordation server circuit,
   to receive a reference to an asset from a event recordation client,
   to receive status from and transmit commands to each event recordation client,
   to receive an encrypted asset from an event recordation client according to bandwidth policy;
an analysis server circuit,
and a distributed storage manager circuit,
   to maintain location of an asset for every event, and
   to retrieve an asset from event recordation client,
   to retrieve an asset from storage server.

In an embodiment the analysis server comprises a circuit:
to decrypt assets for authenticated analysis clients,
to show a timeline of event occurrences,
to provide selection of events.

In an embodiment the analysis server comprises a circuit:
to decrypt video assets for authenticated analysis clients,
to show a video stream for a selected event,
to show a plurality of scaled, still images for a plurality of events;
to show a timeline of event occurrences,
to provide navigation between displays, and selection of events.

In an embodiment the secure video stream event server further comprises:
an analysis server circuit comprising a processor adapted by software to provide
   means for display of still images or video streams
   means for performing regression analysis on event meta data
   means for summarizing event meta data
   means for correlating meta data among related capture clients,
   means for performing specific analysis upon recognition of a trigger event,
   means for categorizing events by meta data, and
   means for alerting a user to a certain pattern of events.

In an embodiment the secure video stream event server further comprises:
an access control circuit comprising a processor adapted by software to provide
   means for associating users with accounts,
   means for associating capture clients with accounts,
   means for associating events with accounts,
   means for decrypting assets exclusively for authenticated users.

In an embodiment the secure video stream event server further comprises:
a bandwidth manager circuit comprising a processor adapted to
   receive a request for live streaming from a certain capture client,
   receive a request for a video stream stored on a capture client,
   reset bandwidth utilization policies for all capture clients, and
   determine relative priority among capture clients.

In an embodiment the secure video stream event server further comprises a processor adapted by software to provide
means for forcing creation of an event,
means for annotating additional meta-data to an event.

In an embodiment the secure video stream event server further comprises a processor adapted by software to provide means for searching and triggering on values and properties of events and meta data.

In an embodiment the secure video stream event server further comprises a processor adapted by software to provide means for selecting and grouping a combination of events and annotating the group.

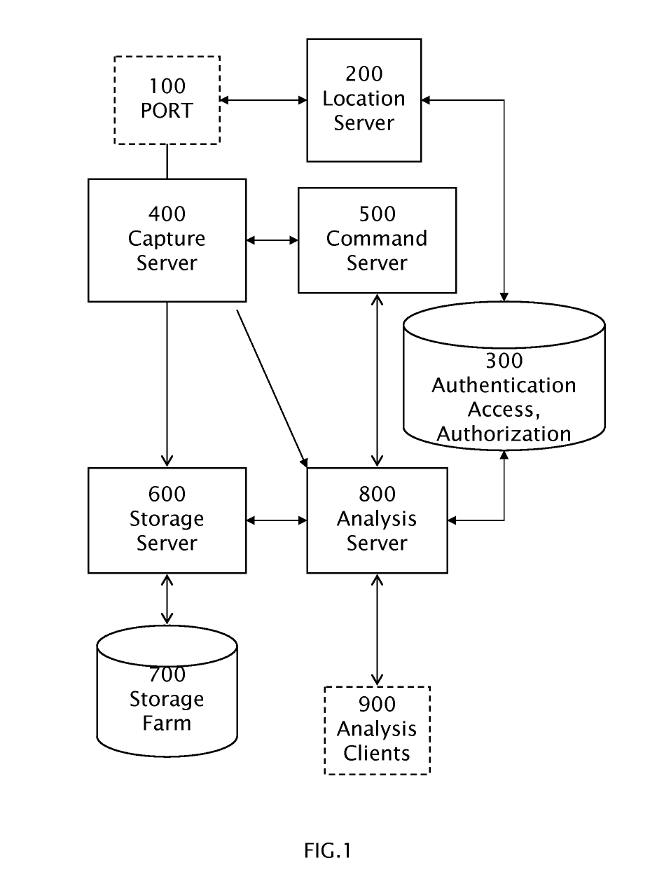

Referring now to FIG. 1, a location server 200 is coupled to a plurality of Point of Recordation Terminals (PORTs) 100 and to an authentication, access, and authorization database 300. An analysis server 800 also couples to the authentication access and authorization database 300 to validate access from a plurality of analysis clients 900. The analysis server 800 further couples to a capture server 400, a command server 500, and a storage server 600. Each capture server 400 is further coupled to a plurality of PORTs 100, the command server 500, and the storage server 600. A storage farm 700 is coupled to the storage server 600.

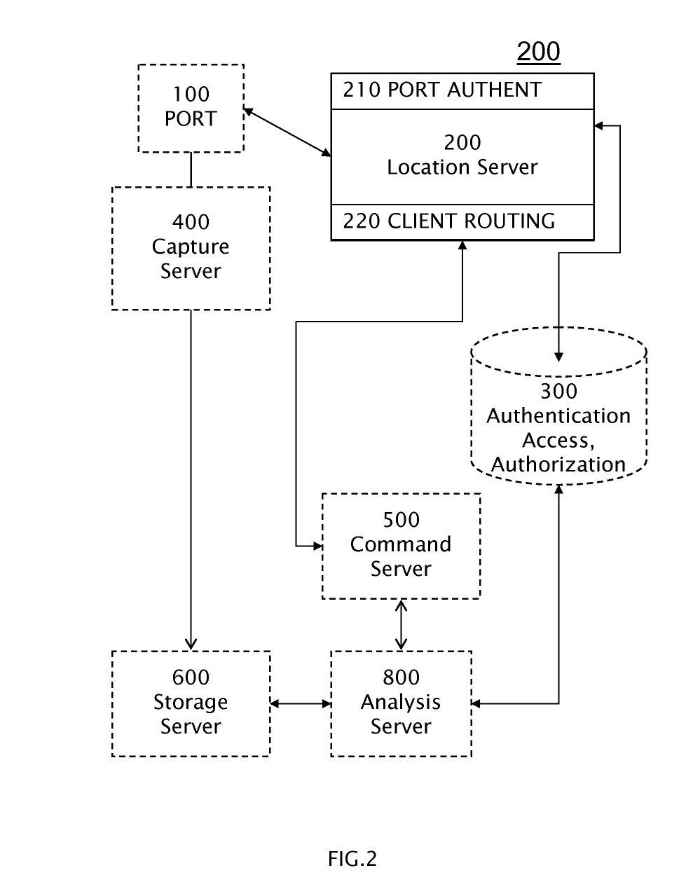

Referring to FIG. 2, each location server 200 presents a fixed IP address which allows PORTs to establish a client session without needing domain name system (DNS) service. The location server comprises
PORT authentication circuit 210 to validate a PORT is a genuine capture client,
client routing circuit 220
to direct PORT to appropriate capture server based on load and configuration information in database, and PORT,
to provide location information to internal servers that need to find this PORT.

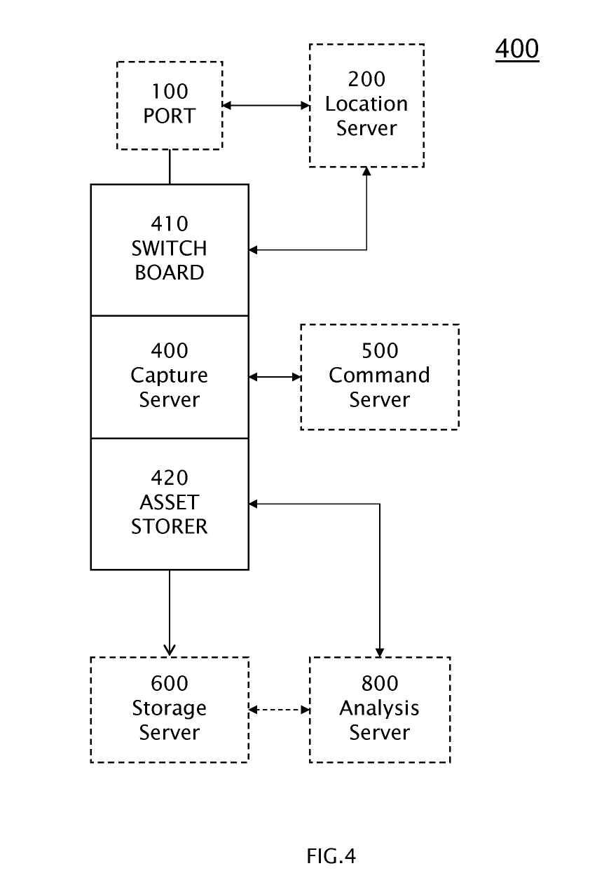

Referring now to FIG. 4 each capture server 400 connects a plurality of PORTs with asset and command connections. The capture server comprises
switchboard 410 to provide rendezvous point for other servers to get status and issue commands to PORTS on the command channel,
asset storer 420 to receive references and assets from PORTS over one or more connections per port. It publishes existence of assets and references as they are being uploaded, which allows other servers to handle them in real time. In a preferred embodiment, assets are transferred and stored in small chunks from PORT over hypertext transfer protocol (HTTP) protocol POST method, allowing live streaming of HTTP uploaded assets.

In an embodiment, the method further comprises
authenticating a PORT as a genuine capture client,
connecting a PORT to a capture server based on load and configuration, and
updating a location lookup table accessible to all servers.

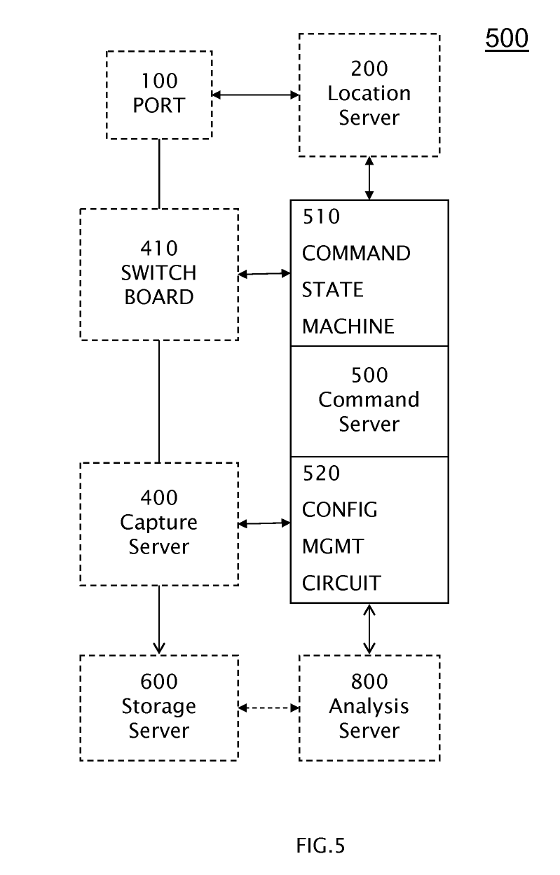

Referring to FIG. 5, the command server 500 converts required action from other servers and configurations into sequences of command transactions sent to PORTs, handles error cases, and interacts with the location server 200 to determine which capture server to use for each PORT. The command server comprises a
command state machine 510 to fetch command sequences from stored command server and execute stated transactions by issuing commands to switchboard 410 and receiving status change updates back.
configuration management circuit 520 to automatically detect current PORT configuration and issues commands to command state machine to drive PORT into target configuration.

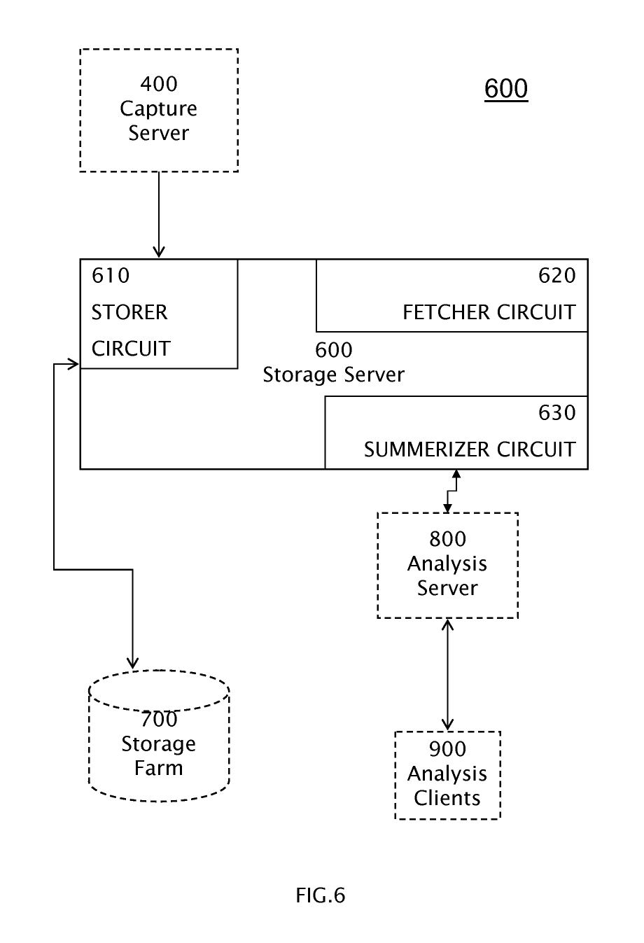

Referring now to FIG. 6, each storage server 600 comprises a
storer circuit 610 to fetch assets and references from capture server 400 and stores them in high volume reliable storage 700, a
fetcher circuit 620 to provide fetch interface for servers, with special handling for references and assets that do not exist of, i.e. fetcher circuit causes command server
to instigate demand upload command and
to set capture server to wait for asset to arrive and a
summarizer circuit 630 to process assets and references to provide a more compact and faster to access representation for analysis server. For example, counts how many assets exist for each 5 minute period and provides a simple table, dramatically accelerating display of day status summaries.

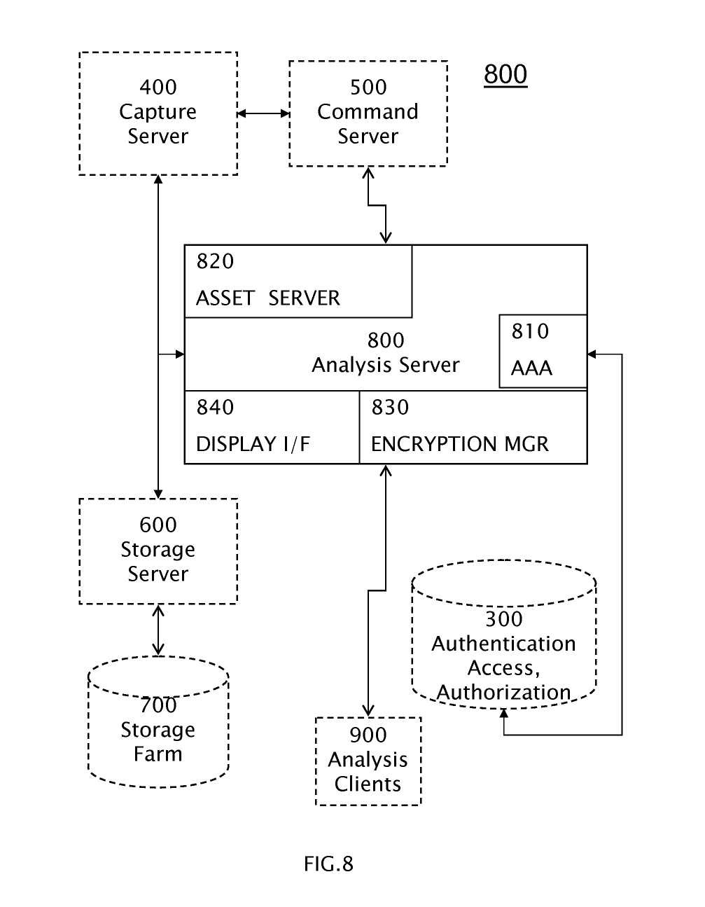

Referring now to FIG. 8, in an embodiment the analysis server 800 provides a mechanism for user access to references, assets, and PORT configuration. The analysis server comprises
a AAA circuit 810 to Authenticate user Access and Authorization,
a asset server 820 to direct a request for an asset from analysis apparatus 900 to storage server 600, and handle redirection to capture server 400 and/or command server 500 in the event a certain asset is not available on storage farm 700,
a display interface 840 to implement controlled access to user, PORT, and system status and configuration in typical tiered server model, and
an encryption manager 830 to associate encryption keys for each specific PORT user. In an embodiment assets are decrypted on the analysis server, and transmitted using standard communication protocols and clients (such as SSL and FLASH) to the analysis apparatus 900. In an embodiment, keys are distributed to authorized analysis clients 900 to allow transmission of assets in encrypted form to the end point.

The present invention is a method for operating a system comprising,
a plurality of analysis clients coupled to an analysis server,
the analysis server coupled to a storage server, and
the storage server.

The method comprises the following processes:
providing seamless access to assets which may be in any one of a plurality of states,
determining a location for an asset currently stored,
directing a request to retrieve an asset from a storage location,
controlling access from a user to the system and to at least one PORT in the assets emanating therefrom,
authenticating a user and providing a decryption key for an asset for display to the user,
fetching assets and storing them in high volume reliable storage,
directing reference fetches to a command server to instigate demand upload, and
processing assets and references into a compact axis representation for display.

In an embodiment, the method further comprises
receiving references and assets from PORTs over one or more connections,
publishing the existence of assets and references as they are being uploaded
converting required actions into a sequence of command transactions to PORTs,
authenticating a PORT and directing its traffic to a certain server, and
adapting a bandwidth policy and updating each PORTs bandwidth policy to accommodate requests for asset uploads.

In an embodiment, a system comprises
a plurality of display clients coupled to a display server,
the display server coupled to a storage server, and
the storage server,
   wherein the storage server contains assets in encrypted format,
   wherein the display server selectively decrypts assets either at the server or at the client depending on client capabilities including use of a reference as indicative of encrypted asset as a means of limiting number of assets decrypted and use of metadata for same, and
   wherein the display server is coupled to a storage server with a means for allowing assets in the process of being stored to also be displayed.

In an embodiment, the system further comprises
a command server, coupled to
a point of recordation terminal (PORT) server, and
a plurality of PORTs coupled by a public wide area network,
wherein each PORT comprises a circuit to initiate transactions for command interactions,
wherein each PORT comprises an encryption circuit whereby assets and references are securely transmitted to a public wide area network, and
wherein a command server comprises a user PORT management circuit, a configuration management circuit, and a command state machine.

In an embodiment, the apparatus comprises at least one event recordation server coupled to both the command server and to the storage server, an event recordation server comprising:
a switchboard circuit, and
an asset storer circuit,
wherein the asset store or circuit receives assets and references over an http protocol POST method initiated by a PORT and transfer encoded as chunks as determined by the PORT and
wherein the switchboard circuit couples all PORTs and all servers enabling the transfer of commands and status between any PORT and any server.

In an embodiment, the apparatus further comprises
a location server coupled to a network interface
   wherein a location server comprises a fixed Internet protocol address whereby any PORT can establish a connection to a camera server without depending on the domain name system, and
   wherein location information is provided to servers which need to find a certain PORT
the location server comprising:
   a client interface which receives connections from PORTS, interface being available at a fixed IP address to avoid client DNS.
   a load balancing service which allocates PORTS to a pool of camera servers
   authentication service which validates the PORT identification information against known PORTS and provide credentials to allow access to camera servers
   a location data base which record the specific camera server a specific port is allocated to
   a location query server which provides the location data to other servers on request;
wherein a service may be implemented by a processor adapted by a program product.

The method of operating a location server comprises
receiving a request from a PORT, which includes identification information of the PORT
authenticating the PORT, wherein authenticating comprises one or more of the steps:
responding to the PORT request with a challenge response and receiving a subsequent request from the PORT with the appropriate response, and
validating the PORT identification information against known good PORTs
   responding to the PORT request with a nonce to use for authenticated access and an IP address to user for camera server transactions.

The method of operating a location server further comprises:
receiving a request from a valid server for the active server to use to rendezvous with a specific PORT
responding to the request with identification information for the specific camera server the PORT is associated with, and
responding with an error response if the PORT is not valid.

In a preferred embodiment, the method comprises
receiving an hypertext transfer protocol POST method request initiated by at least one point of recordation terminal,
receiving a status report from a PORT and transferring it to any server,
receiving a command from any server and transferring it to a PORT,
receiving references and assets from a PORT, and
publishing the existence of assets and references as they are being uploaded.

In an embodiment, the apparatus further comprises
a configuration management circuit coupled to the command state machine, comprising means for
i. controlling the time and calendar of a PORT,
ii. controlling the software configuration of a PORT,
iii. controlling the service configuration of a PORT,
iv. comprising a bandwidth shaping policy as a function of the camera's current storage level.

In an embodiment, the method further comprises
translating user selections in a display apparatus into configuration values and commands,
converting action requests from other servers into a sequence of command transactions,
tracking the status of issued commands, and
receiving an analysis request and initiating an asset upload.

In an embodiment, the method further comprises
automatically detecting a current PORT configuration,
issuing commands to drive a PORT into a target configuration,
setting time and date,
deploying software updates, and
specifying each PORT's bandwidth shaping to control enterprise wide bandwidth management.

In an embodiment, the apparatus further comprises
a storage server comprising
a storer circuit, coupled to a camera server and a high-volume storage and
a fetcher circuit, coupled to a display server and the high-volume storage.

In an embodiment, the apparatus further comprises a summarizer coupled to a display server and a high-volume storage.

In an embodiment, the method further comprises
fetching assets and references from a camera server and storing into high-volume storage,
retrieving assets and references from high-volume storage,
instigating a demand upload command for an asset known to be on a camera, and
handling a request for an asset whose location is unknown.

In an embodiment, the method further comprises
formatting charts and graphs to profile the existence of references and of assets,
processing assets and references to provide a compact representation for transmission to a display apparatus, and
detecting trends and discontinuities among the metadata of stored references and assets.

In an embodiment, the apparatus further comprises
a display server
an authentication and authorization and access circuit, and
a decryption management circuit.

In an embodiment, the apparatus further comprises
an asset locator expediter, and
a system cockpit interface.

In an embodiment, the method further comprises
associating authorized PORTs and public keys with authenticated users,
managing distribution of keys to authorized servers or displays,
transmitting meta data and decrypted references to authorized users, and
receiving requests for transmission of assets.

In an embodiment, the method further comprises
transmitting system and camera configurations and status,
receiving reconfiguration selections and adapting command sequences,
requesting retrieval of assets from storage, and
redirecting requests for assets not presently in storage.

### CONCLUSION

The present patent application discloses a highly secure shared event server receiving and storing encrypted assets and references to those assets over a non-proprietary communication channel. This system selectively decrypts and transmits references and assets to authenticated mutually unconscious users, and retrieves, decrypts and transmits certain assets from high-volume storage, distributed storage, or in transit. The method provides for controlling a plurality of event recordation terminals and a plurality of analysis engines, transmitting policies and commands, requesting upload of assets, and obtaining status solely by receiving client initiated sessions.

The present invention may be easily distinguished from conventional video surveillance systems by serving cameras as clients and receiving hypertext transfer protocol POST method requests. The present invention may be easily distinguished from conventional video surveillance systems by using public networks between the camera and the server and encrypting each cameras video streams with a private key unique to each camera and storing the encrypted videos streams and only decrypting the video streams using a public key upon demand of a user. The present invention may be easily distinguished from conventional video surveillance systems by allocating bandwidth and distributing a bandwidth policy to each camera which autonomously uploads references and video stream assets according to the bandwidth policy. The present invention may be easily distinguished from conventional video surveillance systems by reallocating bandwidth among all cameras when a user requests a video stream asset from a certain camera.

The present invention may be easily distinguished from conventional systems by serving cameras as clients and receiving hypertext transfer protocol POST method requests. The present invention may be easily distinguished from conventional systems by using non-proprietary communication channels between the camera, microphone, or measurement instrument and the server and encrypting each sensory streams with a key unique to each capture device and storing the encrypted sensory streams and only decrypting the sensory streams upon demand of a user. The present invention may be easily distinguished from conventional systems by allocating bandwidth and distributing a bandwidth policy to each PORT which autonomously uploads references and assets according to the bandwidth policy. The present invention may be easily distinguished from conventional systems by reallocating bandwidth among all PORTs when a user requests a sensory stream asset from a certain PORT.

The present invention may be easily distinguished from conventional systems by its isolation of the user from management over the physical location of assets. Assets are automatically moved among and retrieved from the server, the point of recordation or in-flight to the server. To enjoy the economy of using non-proprietary communication channels and high-volume storage but still provide the best security, the invention encrypts data from the point of recordation through storage and only decrypts it exclusively for an authenticated user. A further distinguishing security advantage is passively receiving client initiated sessions from the point of recordation terminals for all management, configuration, and data transfer channels.

The present invention is easily distinguished from conventional system by allowing one or more PORTs to function effectively over lower bandwidth Internet connections and with less impact on other applications using the connection than conventional solutions, while providing effective and timely access to all events recorded by the PORT.

The present invention is easily distinguished from conventional systems by at least:
Cleanly dealing with assets that can be either on the server, in flight to the server, or on the event recordation client apparatus.
Encrypting data on the event recordation client, and keeping it encrypted during storage and possibly transmission
Supporting an “outbound only” management channel from event recordation clients.
Remotely managing event recordation apparatus code base and configuration
Securely intermediating between a plurality of unrelated users and the superset of their event recordation clients installed across non-proprietary communication channels and private LANs
Supporting delayed or unresolved assets
Dynamically managing sensory event recordation apparatus status and operating model.

It is distinctly pointed out that a conventional network security solution such as Secure Sockets Layer Certificates protects only during the transport and fails to accomplish the objective of the present invention. A sensory asset transported by SSL would be stored at the server in unprotected form vulnerable to viewing by unauthorized persons. Nor does an SSL certificate establish a chain of evidence or quantifiably provable provenance from a specific camera, microphone, or measurement instrument as the origin of a video stream. Re-encrypting or signing the asset at the server after transport encryption and decryption would fail to provide provenance and ensure security.

The techniques described herein can be implemented in digital electronic circuitry, or in computer hardware, firmware, software, or in combinations of them to provide means for the following:
an analysis server circuit comprising
   means for displaying scaled still images,
   means for displaying stored video streams,
   means for displaying live feed from a camera,
   means for performing regression analysis on event meta data
   means for summarizing event meta data
   means for correlating meta data among related capture clients,
   means for performing specific analysis upon recognition of a trigger event,
   means for categorizing events by meta data, and
   means for alerting a user to a certain pattern of events;
an access control circuit comprising
   means for associating users with accounts,
   means for associating capture clients with accounts,
   means for associating events with accounts, and
   means for decrypting assets exclusively for authenticated users;
a user interface display and editor providing
   means for forcing creation of an event, and
   means for annotating additional meta-data to an event;
   a database search and analysis circuit providing
   means for searching and triggering on values and properties of events and meta data;
a user interface and navigation display providing
   means for selecting and grouping a combination of events and annotating the group.

The techniques described herein can be implemented in digital electronic circuitry, or in computer hardware, firmware, software, or in combinations of them to provide means for the following:
an analysis server circuit comprising
   means for performing regression analysis on event meta data
   means for summarizing event meta data
   means for correlating meta data among related event recordation clients,
   means for performing specific analysis upon recognition of a trigger event,
   means for categorizing events by meta data, and
   means for alerting a user to a certain pattern of events;
a user interface display and editor providing
   means for forcing creation of an event, and
   means for annotating additional meta-data to an event;
a database search and analysis circuit providing
means for searching and triggering on values and properties of events and meta data;
a user interface and navigation display providing
means for selecting and grouping a combination of events and annotating the group.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

What is claimed is:

1. An apparatus comprising
at least one sensory stream server coupled to both a command server and to a storage server, a sensory stream server comprising:
a switchboard circuit, and
an asset storer circuit,
wherein the asset storer circuit is a processor adapted by software instructions to receive assets and references over a communication channel as determined by a point of recordation terminal (PORT) and
wherein the switchboard circuit couples all PORTs and all servers enabling a transfer of commands or status between any PORT—server pair.

2. The apparatus of claim 1 wherein assets and references comprise representations of chunks of data which represent meaningful partition of a data stream.

3. The apparatus of claim 2 wherein the asset storer circuit is adapted to process data as chunks are received to improve performance and latency in handling large data streams.

4. The apparatus of claim 3 wherein chunks comprise meaningful sensory groupings.

5. The apparatus of claim 4 wherein a meaningful sensory grouping is at least one frame of video.

6. The apparatus of claim 4 wherein a meaningful sensory grouping is at least one sample of audio.

7. The apparatus of claim 1 wherein a communication channel comprises a circuit adapted to perform instructions specified by Internet Protocol standard.

8. The apparatus of claim 7 wherein a communication channel comprises a circuit adapted to perform by TCP/IP specified instructions.

9. The apparatus of claim 8 wherein a communication channel comprises a circuit adapted to perform instructions specified by hypertext transfer protocol standard.

10. The apparatus of claim 9 wherein a communication channel comprises a circuit adapted to perform instructions specified by hypertext transfer protocol standard POST method.

11. The apparatus of claim 10 wherein a communication channel comprises a circuit adapted to perform instructions tangibly embodied on computer readable media and specified by hypertext transfer protocol standard POST method chunk based transfer encoding.

12. The apparatus of claim 1 further comprising
at least one sensory stream server coupled to both a command server and to a storage server, a sensory stream server comprising:
a switchboard circuit, and
an asset storer circuit,
wherein the asset storer circuit is a processor adapted by software to receive assets and references over an http protocol POST method initiated by a PORT and transfer encoded as chunks as determined by the PORT and
wherein the switchboard circuit couples all PORTs and all servers enabling a transfer of at least one command and status between any PORT and any server.

13. The apparatus of claim 1 further comprising
a location server comprising
a PORT authentication circuit and
a PORT routing circuit,
wherein a location server resides at a fixed address known by the PORT whereby any PORT can establish a connection to a location server without depending on a name resolution service or a network service which requires local network knowledge.

14. The apparatus of claim 1 further comprising
a location server comprising
a PORT authentication circuit and
a PORT routing circuit,
wherein a location server comprises a fixed Internet protocol address whereby any PORT can establish a connection to a PORT server without depending on the domain name system, and
whereby location information is provided to servers which need to find a certain PORT.

15. The apparatus of claim 1 further comprising an analysis server coupled to at least one of an analysis client and an analysis process for evaluation of a reference to determine if it is not of further interest or if the event should be elaborated and the referenced asset should be retrieved for additional analysis; the analysis server comprising means for performing regression analysis on event meta data
means for summarizing event meta data
means for correlating meta data among related capture clients,
means for performing specific analysis upon recognition of a trigger event,
means for categorizing events by meta data, and
means for alerting a user to a certain pattern of events.

16. The apparatus of claim one wherein a sensory stream comprises orientation.

17. The apparatus of claim one wherein a sensory stream comprises temperature.

18. The apparatus of claim one wherein a sensory stream comprises pressure.

19. The apparatus of claim one wherein a sensory stream comprises acceleration.

20. The apparatus of claim one wherein a sensory stream comprises electro-magnetic field.

21. The apparatus of claim one wherein a sensory stream comprises audio.

22. The apparatus of claim one wherein a sensory stream comprises video.

23. A secure video stream event server comprising:
a capture server circuit
to receive a reference from a capture client,
to receive status from and transmit commands to each capture client,
to receive encrypted video stream assets from a capture client
according to an bandwidth shaping policy for incremental fulfillment or
according to a demand for immediate fulfillment,
a location manager circuit and
a storage manager circuit,
to maintain location of video assets for every captured event, and
to retrieve video assets from capture client,
to retrieve video assets from storage server, and
an analysis server.

24. The secure video stream event server of claim 23 wherein a video stream asset is an encrypted video stream asset whereby confidentiality is protected over a public communication channel.

25. The secure video stream event server of claim 23 wherein capture server circuit further comprises a circuit:
to enable an authenticated authorized user to access a capture client,
to transmit bandwidth policies to each capture client, and
to transmit a new event capture policy.

26. The secure video stream event server of claim 25 wherein capture server circuit further comprises a circuit:
to transmit a new meta data capture policy.

27. The secure video stream event server of claim 26 wherein capture server circuit further comprises a circuit:
to establish connectivity and status of every capture client.

28. The secure video stream event server of claim 23 wherein the analysis server comprises
one or more display server circuits
to decrypt video assets for authenticated authorized users,
to display references comprising meta data and thumbnails
to show a video stream for a selected event,
to show a plurality of scaled, still images for a plurality of events.
to show a timeline of event occurrences, and
to provide navigation between displays, and selection of events comprising
means for performing regression analysis on event meta data
means for summarizing event meta data
means for correlating meta data among related capture clients,
means for performing specific analysis upon recognition of a trigger event,
means for categorizing events by meta data, and
means for alerting a user to a certain pattern of events.

29. The secure video stream event server of claim 23 wherein the capture server circuit further comprises a circuit:
to enable access to a capture client by an authenticated authorized user,
to transmit bandwidth policies to each capture client, and
to transmit updates to event capture policy.

30. The secure video stream event server of claim 29 wherein the capture server circuit further comprises a circuit:
to transmit updates to meta data capture policy, and

31. The secure video stream event server of claim 30 wherein the capture server circuit further comprises a circuit:
to accept connectivity requests from authenticated capture clients.

32. A method for operating a system,
the system comprising,
a plurality of analysis clients coupled to an analysis server,
the analysis server coupled to a storage server, and
the storage server,
the method comprising the following processes:
providing seamless access to assets which may be in any one of a plurality of states,
determining a location for an asset currently stored, and
directing a request to retrieve an asset from a storage location.

33. The method of claim 32 further comprising:
controlling access from a user to the system and to at least one PORT in the assets emanating therefrom.

34. The method of claim 33 further comprising:
authenticating a user and providing a decryption key for a user to access an asset.

35. The method of claim 34 further comprising:
fetching assets and storing them in high volume reliable storage,

36. The method of claim 35 further comprising:
directing reference fetches to a command server for demand upload.

37. The method of claim 36 further comprising:
processing assets and references into a compact axis display.

38. The method of claim 32 for operating a system wherein a system is a secure system, and the method comprises
authenticating authorized users and
encrypting and decrypting references and assets for said users.

39. The method of claim 38 for operating a system wherein assets are encrypted assets and the method further comprises receiving and storing encrypted assets.

40. The method of claim 39 for operating a system wherein the method further comprises
storing a decryption key for an assets,
authenticating an authorized user before providing a decryption key and one of transmitting the decryption key to a user or
decrypting an asset for an authenticated authorized user.

41. The method of claim 38 further comprising the following processes:
receiving references and assets from PORTs over one or more connections,
publishing the existence of assets and references as they are being uploaded
converting required actions into a sequence of command transactions to PORTs,

42. The method of claim 41 further comprising the following processes:
authenticating a PORT and directing its traffic to a certain server.

43. The method of claim 42 further comprising the following processes:
adapting a bandwidth policy and updating each PORT's bandwidth policy to accommodate requests for asset uploads.

44. The method of claim 43 further comprising the steps following:
associating authorized PORTs and public keys with authenticated users, and
managing distribution of keys to authorized servers or displays.

45. The method of claim 44 further comprising the steps following:
displaying meta data and decrypted references to authorized users, and
receiving requests for transmission of assets.

46. The method of claim 45 further comprising the steps following:
translating user selections in a display into configuration values and commands, and
converting action requests from other servers into a sequence of command transactions.

47. The method of claim 46 further comprising the steps following:
tracking the status of issued commands, and
receiving a user request and initiating an asset upload, wherein an asset is an encrypted video stream.

48. The method of claim 47 further comprising the steps following:
fetching assets and references from a camera server and storing into high-volume storage,
retrieving an asset or reference from high-volume storage, and
handling a request for an asset whose location is unknown.

49. The method of claim 48 further comprising the steps following:
instigating a demand upload command for an asset known to be on a camera.

50. The method of claim 49 further comprising the steps following:
formatting charts and graphs to profile the existence of references and of assets,
processing assets and references to provide a compact visual representation, and
detecting trends and discontinuities among the metadata of stored references and assets.

51. An apparatus coupled to a low-bandwidth communication channel, the channel coupled to a plurality of at least one of a microphone and a camera, the apparatus adapted to receive a compact audio sample or a low resolution still image representative of a larger digital stream stored at the microphone or camera.

52. The apparatus of claim 51 further comprising a circuit to respond to at least one of a microphone and a camera with an instruction to upload a stream of data.
